(19) United States
(12) Patent Application Publication
(10) Pub. No.: US 2006/0139935 A1
(43) Pub. Date: Jun. 29, 2006

(54) Cooling device for light emitting diode lamp

(75) Inventor: Meng-Cheng Huang, Taipei (TW)

Correspondence Address: HDSL, 4331 STEVENS BATTLE LANE, FAIRFAX, VA, 22033, US

(73) Assignee: Chaun-Choung Technology Corp.

(21) Appl. No.: 11/022,666

(22) Filed: Dec. 28, 2004

(51) Int. Cl. F21V 29/00

(52) U.S. Cl. 362/373

(57) ABSTRACT

A cooling device for LED lamp, which is disposed in an LED lamp set, includes a heat pipe. The cooling end of the heat pipe is disposed on the light reflection cover of the lamp set, while the reception end contacts the bottom portion of the light emitter. Therefore, the heat generated from the light emitter is transferred to the heat pipe and then to the light reflection cover. Thereafter, the heat is dissipated to the external environment, thereby achieving the cooling purpose.

### BACKGROUND OF THE INVENTION

The present invention relates generally to a cooling device for light emitting diode (LED) lamp, and more particularly to a cooling device that can dissipate the heat generated by the LED lamp to the external environment by using a heat pipe, thereby enhancing the heat dissipation rate.

In contrast to conventional light bulbs, the light emitting diodes (LEDs) are advantageous in that it is light in weight, power saving, less costly, etc. For this reason, the LEDs are used in lamps and flashlights, for example.

Since the brightness of each single LED is less than a conventional light bulb, one often needs to employ a plurality of LEDs to enhance the overall brightness, thereby achieving the same or larger brightness than the conventional light bulb.

However, the brightness of LEDs is enhanced by increasing the quantities of LEDs and the current flowed therethrough. This brings up the same over heating problem when the current is increased. Since the LEDs are mostly disposed on a circuit board, the heat generated from the LEDs can be dissipated through the two surfaces of the circuit board. However, the circuit boards are generally of a single board made of metallic, acrylic or ceramic materials, which provides only two surfaces to achieve the cooling purpose. Since there are many other heats producing electronic devices, such as capacitors and resistors, disposed on the circuit board, the heat transfer efficiency of the circuit board is thus relatively lowered. Consequently, the conventional means for cooling the LED lamps is insufficient for dissipating heats generated from the high power LEDs. The brightness and power of the LED lamps are thus largely limited.

### BRIEF SUMMARY OF THE INVENTION

The present invention is to provide a cooling device for LED lamp that can transfer the heat generated from the LED lamp set to the light reflection cover, thereby dissipating the heat to the environment.

In order to achieve the above and other objectives, the cooling device for LED lamp of the present invention, which is disposed in an LED lamp set, includes a heat pipe. The cooling end of the heat pipe is disposed on the light reflection cover of the lamp set, while the reception end contacts the bottom portion of the light emitter.

### BRIEF DESCRIPTION OF THE DRAWINGS

FIG. 1 is an explosive view of a cooling device for LED lamp in accordance with one embodiment of the present invention.

FIG. 2 is a perspective view of the cooling device for LED lamp of the present invention.

FIG. 3 is a perspective view of the LED lamp after being assembled.

FIG. 4 is a top view of the cooling device for LED lamp of the present invention.

FIG. 5 is a sectional view of the cooling device for LED lamp of the present invention.

FIG. 6 illustrates a cooling device for LED lamp in accordance with another embodiment of the present invention.

FIG. 7 illustrates a cooling device for LED lamp in accordance with yet another embodiment of the present invention.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

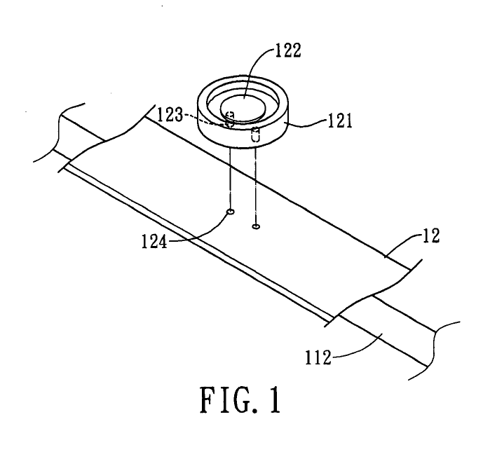

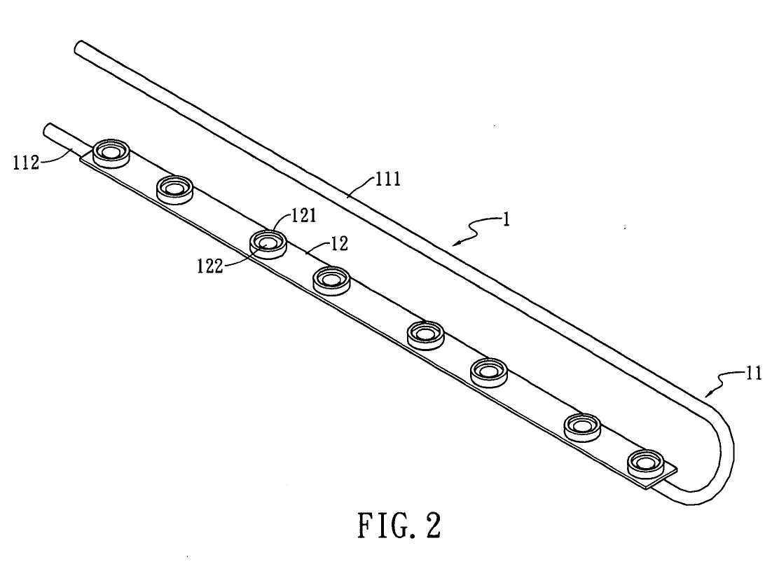

Referring to FIG. 1 and FIG. 2, an explosive view and a perspective view of a cooling device for LED lamp are illustrated, respectively. As shown, the cooling device for LED lamp includes a heat pipe 11, which is combined with the LED lamp set 1, thereby transferring the heat generated from the LED lamp set 1 to the external environment.

The LED lamp set 1 includes a heat pipe 11. The heat pipe 11 includes a cooling end 111 and a reception end 112. The reception end 112 includes a circuit board 12 disposed thereon. A plurality of lamp mount 121 is disposed on the circuit board 12. The circuit board 12 and the reception end 112 of the heat pipe 11 are combined and assembled by means of soldering.

The lamp mount 121 includes a light emitter 122 packaged therein. In this particular embodiment, the light emitter 122 is an LED. The pins 123 of each light emitter 122 are connected with the through hole 124 of the circuit board 12. The heat generated from the light emitter 122 is then transferred to the reception end 11 of the heat pipe for dissipating to the environment.

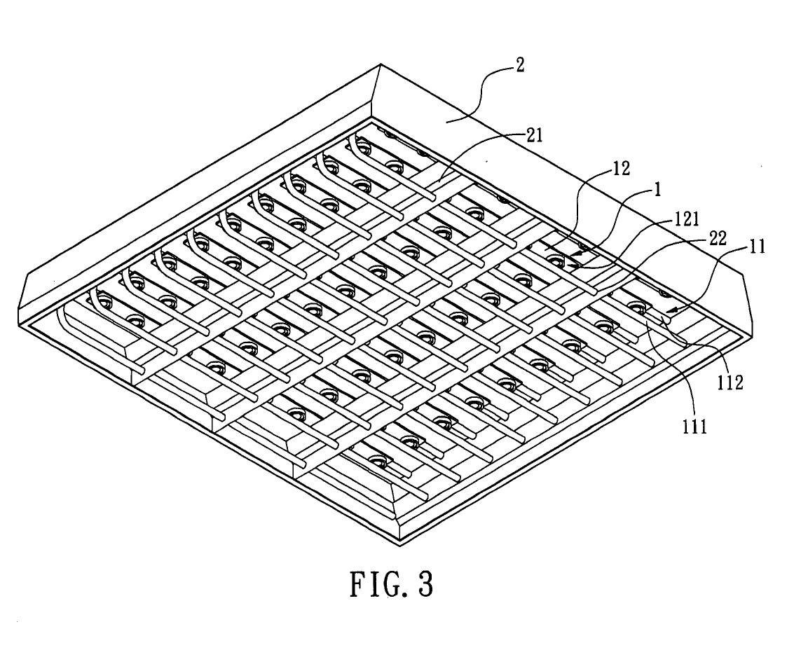

Referring to FIG. 3, a perspective view of the LED lamp after being assembled is illustrated. The cooling end 111 of the heat pipe 11 is disposed on the through hole 22 formed on the separator 21 of the light reflection cover 2. When the heat pipe 11 is disposed on the light reflection cover 2, the cooling end 111 is shifted along the lamp mount 121 without corresponding to the lamp mount 12. Therefore, the light generated from the light emitter 122 is not blocked.

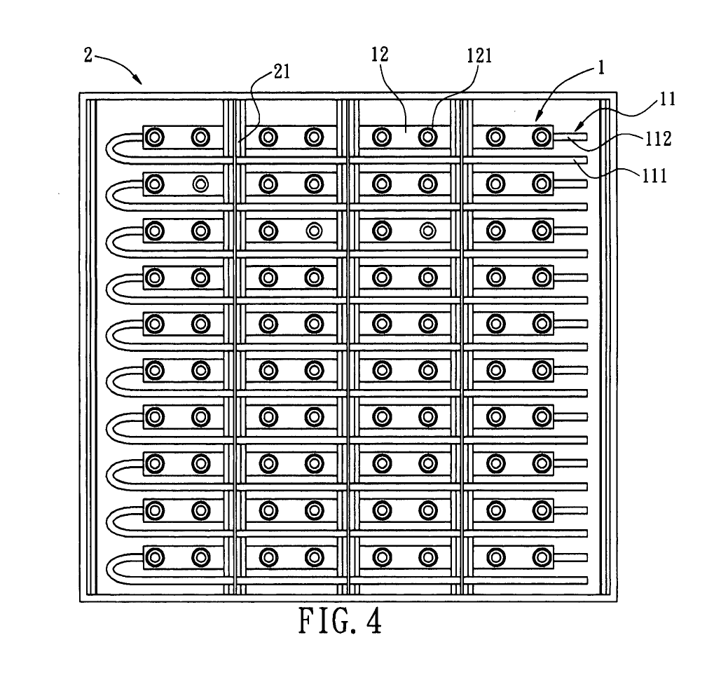

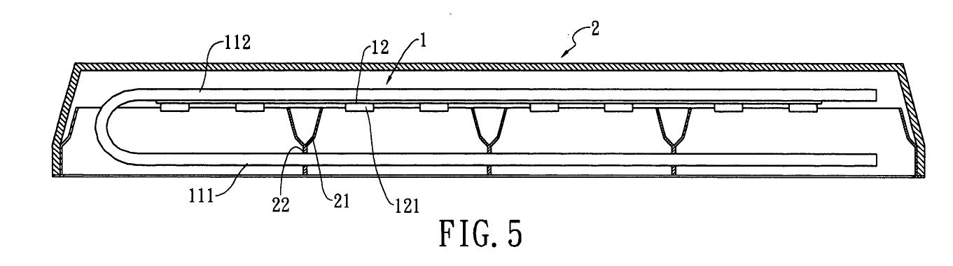

Referring to FIG. 3, FIG. 4 and FIG. 5, a perspective view, a top view and a sectional view of the cooling device for LED lamp are illustrated, respectively. As shown, a power source (not shown) is connected to the circuit board 12 after the cooling device for LED lamp of the present invention is assembled on the light reflection cover 2. The light emitter 122 then projects out light source for illumination. When the light emitter 122 is projecting light source, heat is also generated. The heat is then transferred to the reception end 112 of the heat pipe 11, and later to the cooling end 111. The heat is further transferred from the cooling end 111 to the aluminum separator 21 of the light reflection cover 2. Since the light reflection cover 2 is exposed to the environment, the heat generated from the LED lamp set 1 is then dissipated to the external environment. Therefore, the heat from the LED lamp set 1 is effectively dissipated, and the life of the light emitter 12 can be extended.

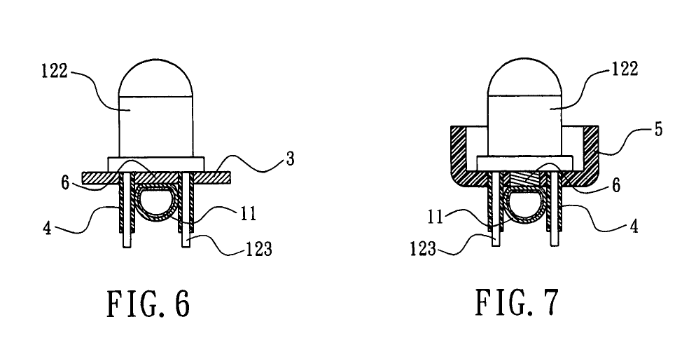

Referring to FIG. 6, the cooling device for LED lamp in accordance with another embodiment of the present invention is illustrated. As shown, the light emitter 122 in this particular embodiment is disposed on a heat conducting plate 3 made of a metallic material. In addition, a heat pipe 11 is disposed at the bottom portion of the heat conducting plate 3. In order to prevent the short circuitry of the two pins 123 of the light emitter 122 from happening due to the presence of the heat conducting plate 3 and the heat pipe 11, an insulator 4 is harnessed on the two pins 123. After the two pins 123 are connected to the power source, the heat generated from the light emitter 12 can be absorbed through the heat conducting plate 3 and transferred to the heat pipe 11 for further dissipation. In this manner, the life of the light emitter 122 can be extended.

Referring to FIG. 7, a cooling device for LED lamp in accordance with yet another embodiment of the present invention is illustrated. As shown, the light emitter 122 in this particular embodiment is disposed on a mount 5 made of a plastic material. A heat conducting element 6 made of a metallic material is embedded in the mount 5 contacting the bottom portion of the light emitter 122. In addition, a heat pipe 11 is disposed at the other side of the heat conducting element 6. In order to prevent the short circuitry of the two pins 123 of the light emitter 122 from happening due to the presence of the heat pipe 11, an insulator 4 is harness on the two pins 123. After the two pins 123 are connected to the power source, the heat generated from the light emitter 12 can be absorbed through the heat conducting element 6 and transferred to the heat pipe 11 for further dissipation. In this manner, the life of the light emitter 122 can be extended.

In summary, the cooling device for LED lamp of the present invention can indeed solve the problems of the conventional device. The heat generated from the LED lamp set can be transferred to the light reflection cover via the heat pipe, and further dissipated to the external environment via the light reflection cover. Therefore, the cooling device for LED lamp of the present invention satisfies the novelty, non-obviousness and utility requirements in the patent law, the present utility patent application is thus filed and a grant of letters patent therefor is respectfully requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A cooling device for light emitting diode lamp, comprising:
a light emitter; and
a heat pipe, which comprises a reception end and a cooling end, the reception end contacting the bottom portion of the light emitter,
whereby the heat generated from the light emitter is transferred to the heat pipe for further dissipation.

2. The device as recited in claim 1, wherein the light emitter comprises a light emitting diode.

3. The device as recited in claim 1, wherein the light emitter is disposed in a lamp mount, the pins of the light emitter being extended outside of the lamp mount for connecting therewith a conducting wire.

4. The device as recited in claim 1, wherein a circuit board is disposed between the light emitter and the heat pipe, a plurality of through holes being disposed on the circuit board for the pins of the light emitter to penetrate therethrough and be soldered thereon.

5. The device as recited in claim 4, wherein the circuit board comprises at least a light emitter soldered thereon, and a power source is provided to the light emitter via the circuit board.

6. The device as recited in claim 1, wherein a heat conducting plate made of a metallic material is disposed between the light emitter and the heat pipe, and an insulator is harnessed on the two pins for preventing short circuitry of the two pins from happening due to the presence of the heat conducting plate and the heat pipe.

7. The device as recited in claim 1, wherein a mount made of a plastic material is disposed between the light emitter and the heat pipe, a heat conducting element is embedded into the mount contacting the bottom portion of the light emitter, and an insulator is harnessed on the two pins for preventing short circuitry of the two pins from happening due to the presence of the heat pipe.

8. A cooling device for LED lamp, comprising:
a light reflection cover;
a light emitter; and
a heat pipe, which comprises a reception end and a cooling end, the reception end contacting the bottom portion of the light emitter,
whereby the heat generated from the light emitter is transferred to the heat pipe for further dissipation.

9. The device as recited in claim 8, wherein the light reflection cover comprises a plurality of separators.

10. The device as recited in claim 9, wherein the light reflection cover and the separator are made of aluminum, the separator having a plurality of through holes for disposing thereon the cooling end of the heat pipe.
